(19) United States
(12) Patent Application Publication
(10) Pub. No.: US 2023/0328000 A1
(43) Pub. Date: Oct. 12, 2023

(54) SYSTEMS AND METHODS OF DYNAMIC DISCARD TIMER ADJUSTMENT FOR WIRELESS COMMUNICATION

(71) Applicant: Meta Platforms Technologies, LLC, Menlo Park, CA (US)

(72) Inventors: Ping Wang, Redmond, WA (US); Achaleshwar Sahai, San Jose, CA (US); Swaminathan Balakrishnan, Los Gatos, CA (US); Yi Lu, Kirkland, WA (US); Yee Sin Chan, San Francisco, CA (US); Xiaodi Zhang, San Ramon, CA (US)

(21) Appl. No.: 18/078,659

(22) Filed: Dec. 9, 2022

Related U.S. Application Data
(60) Provisional application No. 63/322,816, filed on Mar. 23, 2022.

(51) Int. Cl. H04L 47/56; H04L 47/32; H04W 76/14

(52) U.S. Cl. CPC H04L 47/32; H04L 47/56; H04W 76/14

(57) ABSTRACT

Disclosed herein are aspects related to a device including a wireless communication interface and one or more processors. In an aspect, the wireless communication interface can establish a wireless connection with a remote device. In an aspect, the one or more processors can determine a signal indicative of a value of a discard timer according to at least one of a type of an application implemented by the one or more processors, a type of data communicated over the wireless connection, or a hardware capability of the device. In an aspect, the discard timer can be for discarding data packets from one or more buffers. In an aspect, the one or more processors can provide the signal to the remote device.

### CROSS-REFERENCE TO RELATED APPLICATIONS

This application claims the benefit of and priority to U.S. Application No. 63/322,816, filed Mar. 23, 2022, the contents of which are incorporated by reference in their entirety for all purposes.

### FIELD OF DISCLOSURE

The present disclosure is generally related to wireless communication, including but not limited to dynamically adjusting discard timer for wireless communication.

### BACKGROUND

Developments in computing devices and communication devices have prompted growth in wearable technology. Wearable devices may integrate various components in a compact form, such that the wearable devices can be portable yet perform complex processes. For example, a wearable device may be a smart watch that may access content over the network, and may control or communicate with other computing devices, etc. For example, a wearable device may be a head mounted display (HMD) that may present artificial reality (e.g., virtual reality, augmented reality, mixed reality, etc.).

### SUMMARY

Various implementations disclosed herein are related to a device including a wireless communication interface and one or more processors. The wireless communication interface can establish a wireless connection with a remote device. The one or more processors can determine a signal indicative of a value of a discard timer according to at least one of a type of an application implemented by the one or more processors, a type of data communicated over the wireless connection, or a hardware capability of the device. The discard timer can be for discarding data packets from one or more buffers. The one or more processors can provide the signal to the remote device.

In some implementations, the one or more processors can determine the value and can provide the signal to the remote device subsequent to the wireless communication interface establishing the wireless connection with the remote device. At least one of the wireless communication interface or the one or more processors can operate a particular buffer of the one or more buffers for transmitting data from the device to the remote device. The at least one of the wireless communication interface or the one or more processors can assign a data packet generated by the application to the particular buffer. The at least one of the wireless communication interface or the one or more processors can initiate a timer responsive to determining that the data packet comprises data of a type for discard. The at least one of the wireless communication interface or the one or more processors can periodically increment the timer while the data packet is in the particular buffer. The at least one of the wireless communication interface or the one or more processors can discard the data packet responsive to the timer meeting or exceeding the value of the discard timer.

In some implementations, the device can provide the signal as a user equipment assistance information signal. The user equipment assistance information signal can be transmitted to the remote device differently than data generated by the application. The remote device can be a base station.

In some implementations, the one or more buffers include at least one de-jitter buffer. The de-jitter buffer can store data packets that include at least one of image data or voice data. The one or more processors can determine the hardware capability according to a size of a particular buffer of the one or more buffers.

In some implementations, the one or more processors provide the signal to the remote device for the remote device to set a value of a discard timer of a particular buffer of the one or more buffers according to the signal. The type of application can include at least one of an extended reality application, an augmented reality application, or a virtual reality application.

Various implementations disclosed herein relate to a method. The method can include determining, by one or more processors of a first device, a signal indicative of a value of a discard timer. The signal can be determined according to at least one of a type of an application implemented by the one or more processors, a type of data communicated over the wireless connection, or a hardware capability of the first device, wherein the discard timer is for discarding data packets from one or more buffers. The signal can be provided by the one or more processors to a second device.

In some implementations, the method includes determining the value subsequent to the wireless communication interface establishing the wireless connection with the remote device. The method can include assigning, by the first device, a data packet generated by the application to the particular buffer. The method can include initiating, by the first device, a timer responsive to determining that the data packet comprises data of a type for discard. The method can include periodically incrementing, by the first device, the timer while the data packet is in the particular buffer. The method can include discarding, by the first device, the data packet responsive to the timer meeting or exceeding the value of the discard timer.

In some implementations, the method includes providing, by the one or more processors, the signal as a user equipment assistance information signal. The user equipment assistance information signal can be transmitted to the second device differently than data generated by the application. The second device can be a base station. The type of application can be at least one of an extended reality application, an augmented reality application, or a virtual reality application.

In some implementations, the one or more buffers include at least one de-jitter buffer. The de-jitter buffer can store data packets that include at least one of image data or voice data.

In some implementations, the method can include setting, by the second device, a value of a discard timer of a particular buffer of the one or more buffers according to the signal., wherein the second device is a base station. The method can include determining, by the one or more processors, the hardware capability according to a size of a particular buffer of the one or more buffers.

Various implementations disclosed herein related to a non-transitory computer readable medium. The non-transitory computer readable medium can store instructions that when executed by one or more processors of a device, cause the one or more processors to determine a signal indicative of a value of a discard timer according to at least one of a type of an application implemented by the one or more processors, a type of data communicated over the wireless connection, or a hardware capability of the device, the discard timer for discarding data packets from a de-jitter buffer. The instructions can cause the one or more processors to provide the signal to a base station.

In some implementations, the instructions can cause the one or more processors to provide the signal to the base station as a user equipment assistance information signal during establishment of or subsequent to a wireless communication interface establishing a wireless connection with the base station. The data communicated over the wireless connection can include at least one of audio data, image data, tracking data, sensor data, or video data. The type of application can include at least one of an extended reality application, an augmented reality application, or a virtual reality application.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing.

FIG. 1 is a diagram of a wireless communication system, according to an example implementation of the present disclosure.

FIG. 2 is a diagram of a dynamic discard timer adjustment system, according to an example implementation of the present disclosure.

FIG. 3 is a diagram of a method for dynamic discard timer adjustment, according to an example implementation of the present disclosure.

FIG. 4 is a diagram of a console and a head wearable display for presenting augmented reality or virtual reality, according to an example implementation of the present disclosure.

FIG. 5 is a diagram of an example of a wearable device communication system, according to an example implementation of the present disclosure.

FIG. 6 is a diagram of a head wearable display, according to an example implementation of the present disclosure.

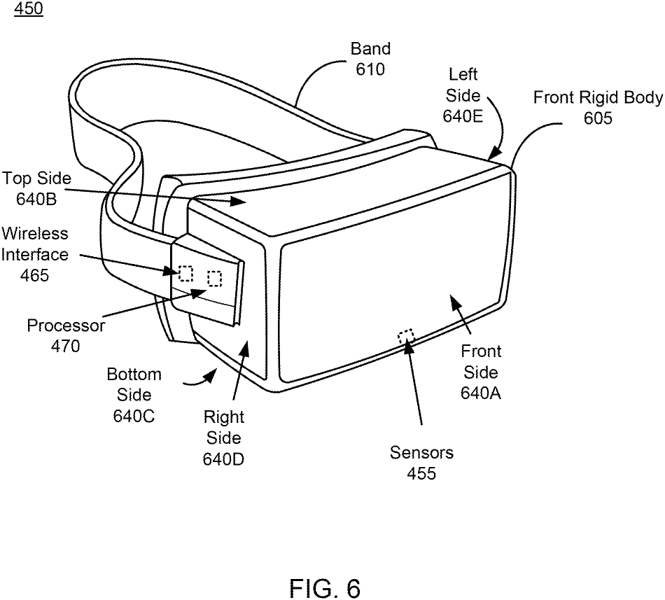

FIGS. 7A and 7B are diagrams of wearable devices, according to an example implementation of the present disclosure.

FIG. 8 is a block diagram of a computing environment according to an example implementation of the present disclosure.

### DETAILED DESCRIPTION

Before turning to the figures, which illustrate certain implementations in detail, it should be understood that the present disclosure is not limited to the details or methodology set forth in the description or illustrated in the figures. It should also be understood that the terminology used herein is for the purpose of description only and should not be regarded as limiting.

Systems and devices that implement network communications can use discard timers to selectively discard data packets instead of transmitting the data packets to a receiving device. For example, communication protocols such as 5G NR/LTE may initiate a discard timer responsive to entering a data packet in a buffer, such as a radio access network (RAN) buffer of a base station or other device operating as a transmitting device, and can discard (rather than transmit) the data packet responsive to the discard timer meeting or exceeding a threshold discard timer value. This may be used, for example, for types of data communications that have timing considerations. For example, extended reality, computer graphic, and/or artificial reality data, such as image data, video data, tracking data, sensor data, and/or audio data, may be limited in usefulness to the receiving device (e.g., to a user of the receiving device) or may disrupt the experience presented by the receiving device when received with a significant delay; as a particular example, if the receiving device is presenting content including a sequence of images and corresponding audio data, a particular image of the sequence of images may not be useful if received after a sequentially later image and/or out of synchronization with audio data mapping to the content of the particular image. As such, systems and devices that implement discard timers can avoid transmission of packets that might otherwise not be useful to an application layer or may be discarded by the application layer due to the delay, which can conserve radio resources and facilitate more efficient utilization of radio resources.

In some systems, the discard timer (e.g., the threshold discard timer value) is associated with a particular communication path, such as a radio data bearer or a radio link control (RLC) logical channel. The discard timer may be/have a predetermined value selected from a plurality of predetermined values, such as values of 10 milliseconds (ms), 1500 ms, infinity (e.g., no discard timer), with predetermined gradations between the predetermined values, such as 10 ms increments between predetermined values. This may not be suitable for applications that communicate data flows that have multiple types of data associated with different sensitivities to delay and/or different expectations for packet discard or loss. For example, artificial reality or extended reality data flows may have multiple of audio, video, depth, and/or pose types of data, at least some of which may have different criteria with respect to delays. In instances in which the data flows are mapped onto a same communication path, such as a same or single radio data bearer or RLC logical channel, applying the same discard timer to each of these types of data in the data flow may lead to inefficient communications, such as packets being discarded even if they might still be used by the application layer or other components of the receiving device, or packets not being discarded even if they are no longer useable by the application layer or other components of the receiving device.

Some devices, such as base stations, configure the discard timer independent of or otherwise without using information regarding the receiving device, such as information regarding the applications of the application layer or criteria associated with operation of the applications; as such, the discard timer may not be configured to an effective value. Factors such as a size of a device de-jitter buffer and error correction processes, such as application layer forward error correction (FEC), may also affect whether the discard timer is effectively configured; for example, a larger de-jitter buffer may allow for longer discard timers while still meeting performance criteria.

Systems, devices, and methods in accordance with the present disclosure can more effectively and flexibly use discard timers, including by providing information to assist in discard timer determination to a base station. For example, information indicative of application and hardware capability can be provided by a first device (e.g., user equipment) to the base station. The information can be provided using a user equipment assistance information (UAI) process. The values of the discard timer can be more flexible, such as to correspond to each application or type of application operating on the first device. The base station can implement the flexible discard timer configuration for various types or levels of data flow management, such as for a particular data radio bearer, or one or more quality of service (QoS) flows. The base station can update the discard timer configuration responsive to receiving the information (e.g., UAI information), such as to periodically update the discard timer configuration responsive to instances of receiving information indicating application and/or hardware capability or performance criteria. The information can include application data unit (ADU) information, which the base station can use to differentiate amongst data flows, such as to apply different or otherwise particularly configured discard timers to respective data flows (rather than a single predetermined value regardless of types of data flows). The user equipment, such as a modem of the user equipment, can retrieve similar or identical information from the application and/or application layer of the user equipment to select discard timer values and control packet discarding. Various such operations can facilitate better user experience and radio resource utilization, such as by enabling a greater proportion of data packets to be communicated to meet more specific and appropriate time-related criteria.

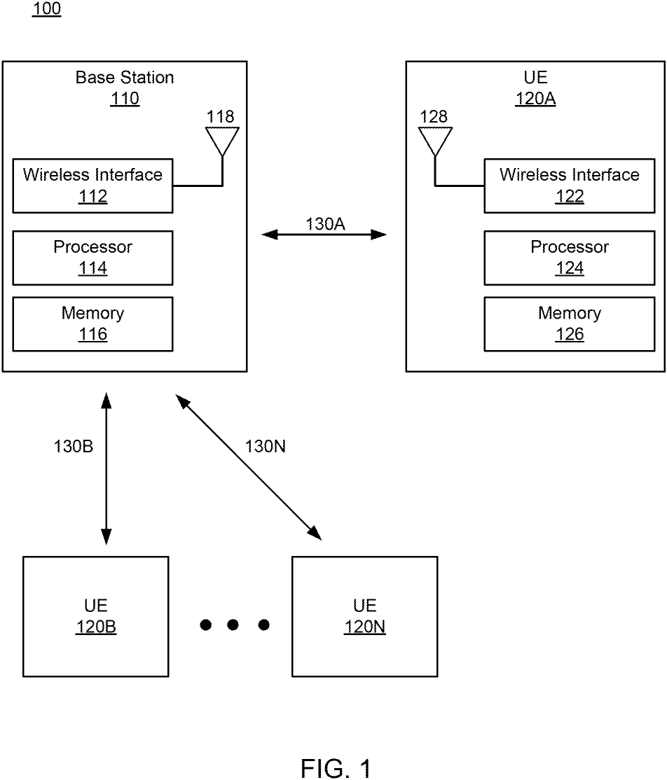

FIG. 1 illustrates an example wireless communication system 100. The wireless communication system 100 may include a base station 110 (also referred to as “a wireless communication node 110” or “a station 110”) and one or more user equipments (UEs) 120 (also referred to as “wireless communication devices 120” or “terminal devices 120”). The base station 110 and the UEs 120 may communicate through wireless commination links 130A, 130B, 130C. The wireless communication link 130 may be a cellular communication link conforming to 3G, 4G, 5G or other cellular communication protocols. In one example, the wireless communication link 130 supports, employs or is based on an orthogonal frequency division multiple access (OFDMA). In one aspect, the UEs 120 are located within a geographical boundary with respect to the base station 110, and may communicate with or through the base station 110. In some implementations, the wireless communication system 100 includes more, fewer, or different components than shown in FIG. 1. For example, the wireless communication system 100 may include one or more additional base stations 110 than shown in FIG. 1.

In some implementations, the UE 120 may be a user device such as a mobile phone, a smart phone, a personal digital assistant (PDA), tablet, laptop computer, wearable computing device, etc. Each UE 120 may communicate with the base station 110 through a corresponding communication link 130. For example, the UE 120 may transmit data to a base station 110 through a wireless communication link 130, and receive data from the base station 110 through the wireless communication link 130. Example data may include audio data, image data, text, etc. Communication or transmission of data by the UE 120 to the base station 110 may be referred to as an uplink communication. Communication or reception of data by the UE 120 from the base station 110 may be referred to as a downlink communication. In some implementations, the UE 120A includes a wireless interface 122, a processor 124, a memory device 127, and one or more antennas 128. These components may be embodied as hardware, software, firmware, or a combination thereof. In some implementations, the UE 120A includes more, fewer, or different components than shown in FIG. 1. For example, the UE 120 may include an electronic display and/or an input device. For example, the UE 120 may include additional antennas 128 and wireless interfaces 122 than shown in FIG. 1.

The antenna 128 may be a component that receives a radio frequency (RF) signal and/or transmit a RF signal through a wireless medium. The RF signal may be at a frequency between 200 MHz to 100 GHz. The RF signal may have packets, symbols, or frames corresponding to data for communication. The antenna 128 may be a dipole antenna, a patch antenna, a ring antenna, or any suitable antenna for wireless communication. In one aspect, a single antenna 128 is utilized for both transmitting the RF signal and receiving the RF signal. In one aspect, different antennas 128 are utilized for transmitting the RF signal and receiving the RF signal. In one aspect, multiple antennas 128 are utilized to support multiple-in, multiple-out (MIMO) communication.

The wireless interface 122 includes or is embodied as a transceiver for transmitting and receiving RF signals through a wireless medium. The wireless interface 122 may communicate with a wireless interface 112 of the base station 110 through a wireless communication link 130A. In one configuration, the wireless interface 122 is coupled to one or more antennas 128. In one aspect, the wireless interface 122 may receive the RF signal at the RF frequency received through antenna 128, and downconvert the RF signal to a baseband frequency (e.g., 0~1 GHz). The wireless interface 122 may provide the downconverted signal to the processor 124. In one aspect, the wireless interface 122 may receive a baseband signal for transmission at a baseband frequency from the processor 124, and upconvert the baseband signal to generate a RF signal. The wireless interface 122 may transmit the RF signal through the antenna 128.

The processor 124 is a component that processes data. The processor 124 may be embodied as field programmable gate array (FPGA), application specific integrated circuit (ASIC), a logic circuit, etc. The processor 124 may obtain instructions from the memory device 127, and executes the instructions. In one aspect, the processor 124 may receive downconverted data at the baseband frequency from the wireless interface 122, and decode or process the downconverted data. For example, the processor 124 may generate audio data or image data according to the downconverted data, and present an audio indicated by the audio data and/or an image indicated by the image data to a user of the UE 120A. In one aspect, the processor 124 may generate or obtain data for transmission at the baseband frequency, and encode or process the data. For example, the processor 124 may encode or process image data or audio data at the baseband frequency, and provide the encoded or processed data to the wireless interface 122 for transmission.

The memory device 127 is a component that stores data. The memory device 127 may be embodied as random access memory (RAM), flash memory, read only memory (ROM), erasable programmable read-only memory (EPROM), electrically erasable programmable read-only memory (EEPROM), registers, a hard disk, a removable disk, a CD-ROM, or any device capable for storing data. The memory device 127 may be embodied as a non-transitory computer readable medium storing instructions executable by the processor 124 to perform various functions of the UE 120A disclosed herein. In some implementations, the memory device 127 and the processor 124 are integrated as a single component.

In some implementations, each of the UEs 120B... 120N includes similar components of the UE 120A to communicate with the base station 110. Thus, detailed description of duplicated portion thereof is omitted herein for the sake of brevity.

In some implementations, the base station 110 may be an evolved node B (eNB), a serving eNB, a target eNB, a femto station, or a pico station. The base station 110 may be communicatively coupled to another base station 110 or other communication devices through a wireless communication link and/or a wired communication link. The base station 110 may receive data (or a RF signal) in an uplink communication from a UE 120. Additionally or alternatively, the base station 110 may provide data to another UE 120, another base station, or another communication device. Hence, the base station 110 allows communication among UEs 120 associated with the base station 110, or other UEs associated with different base stations. In some implementations, the base station 110 includes a wireless interface 112, a processor 114, a memory device 117, and one or more antennas 118. These components may be embodied as hardware, software, firmware, or a combination thereof. In some implementations, the base station 110 includes more, fewer, or different components than shown in FIG. 1. For example, the base station 110 may include an electronic display and/or an input device. For example, the base station 110 may include additional antennas 118 and wireless interfaces 112 than shown in FIG. 1.

The antenna 118 may be a component that receives a radio frequency (RF) signal and/or transmit a RF signal through a wireless medium. The antenna 118 may be a dipole antenna, a patch antenna, a ring antenna, or any suitable antenna for wireless communication. In one aspect, a single antenna 118 is utilized for both transmitting the RF signal and receiving the RF signal. In one aspect, different antennas 118 are utilized for transmitting the RF signal and receiving the RF signal. In one aspect, multiple antennas 118 are utilized to support multiple-in, multiple-out (MIMO) communication.

The wireless interface 112 includes or is embodied as a transceiver for transmitting and receiving RF signals through a wireless medium. The wireless interface 112 may communicate with a wireless interface 122 of the UE 120 through a wireless communication link 130. In one configuration, the wireless interface 112 is coupled to one or more antennas 118. In one aspect, the wireless interface 112 may receive the RF signal at the RF frequency received through antenna 118, and downconvert the RF signal to a baseband frequency (e.g., 0~1 GHz). The wireless interface 112 may provide the downconverted signal to the processor 124. In one aspect, the wireless interface 122 may receive a baseband signal for transmission at a baseband frequency from the processor 114, and upconvert the baseband signal to generate a RF signal. The wireless interface 112 may transmit the RF signal through the antenna 118.

The processor 114 is a component that processes data. The processor 114 may be embodied as FPGA, ASIC, a logic circuit, etc. The processor 114 may obtain instructions from the memory device 117, and executes the instructions. In one aspect, the processor 114 may receive downconverted data at the baseband frequency from the wireless interface 112, and decode or process the downconverted data. For example, the processor 114 may generate audio data or image data according to the downconverted data. In one aspect, the processor 114 may generate or obtain data for transmission at the baseband frequency, and encode or process the data. For example, the processor 114 may encode or process image data or audio data at the baseband frequency, and provide the encoded or processed data to the wireless interface 112 for transmission. In one aspect, the processor 114 may set, assign, schedule, or allocate communication resources for different UEs 120. For example, the processor 114 may set different modulation schemes, time slots, channels, frequency bands, etc. for UEs 120 to avoid interference. The processor 114 may generate data (or UL CGs) indicating configuration of communication resources, and provide the data (or UL CGs) to the wireless interface 112 for transmission to the UEs 120.

The memory device 117 is a component that stores data. The memory device 117 may be embodied as RAM, flash memory, ROM, EPROM, EEPROM, registers, a hard disk, a removable disk, a CD-ROM, or any device capable for storing data. The memory device 117 may be embodied as a non-transitory computer readable medium storing instructions executable by the processor 114 to perform various functions of the base station 110 disclosed herein. In some implementations, the memory device 117 and the processor 114 are integrated as a single component.

In some implementations, communication between the base station 110 and the UE 120 is based on one or more layers of Open Systems Interconnection (OSI) model. The OSI model may include layers including: a physical layer, a Medium Access Control (MAC) layer, a Radio Link Control (RLC) layer, a Packet Data Convergence Protocol (PDCP) layer, a Radio Resource Control (RRC) layer, a Non Access Stratum (NAS) layer or an Internet Protocol (IP) layer, and other layer.

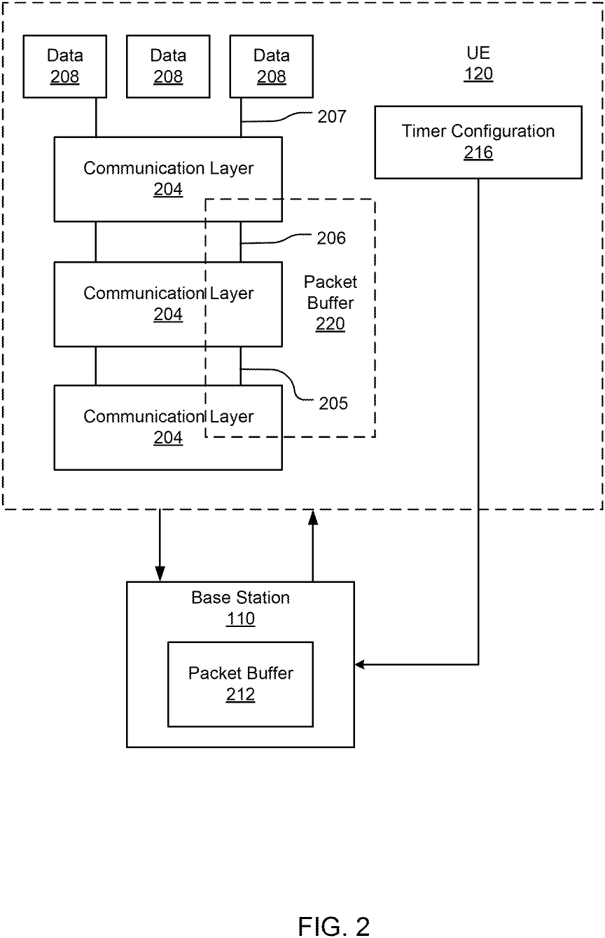

FIG. 2 is a block diagram of an example of a system 200. The system 200 can implement operations including flexible configuration of discard timers (e.g., threshold values of discard timers) according to particular characteristics or parameters of components of the system 200. The system 200 can be implemented using various devices and systems described herein, including but not limited to devices of the wireless communication system 100.

As depicted in FIG. 1, the UE 120 can include one or more communication layers 204. The communication layers 204 can be used to perform various processing operations for data 208 to be transmitted from (e.g., on an uplink path) application(s) of an application layers and/or received by (e.g., on a downlink path) application(s). For example, the communication layers 204 can add, modify, remove, or otherwise process header and/or payload information of data packets that include the data 208.

The communication layers 204 can include a packet data convergence protocol (PDCP) layer 204 (which may correspond to the layer 204 closest to the data 208 as depicted in FIG. 2), a radio link control (RLC) layer 204 (which may correspond to the layer 204 below the PDCP layer 204 as depicted in FIG. 2), and a media access control (MAC) layer 204 (which may correspond to the layer 204 below the RLC layer 204). The communication layers 204 can include or be coupled with various other layers, such as a physical layer to manage transmission and/or reception of wireless communication signals, a radio resource control (RRC) layer to control communication establishing and releasing and communicating system information, a service data adaptation protocol (SDAP) layer to manage quality of service (QoS) data flows, an application layer for communication of data packets to or from applications, or various combinations thereof. The data packets processed by the communication layers 204 can be protocol data units (PDUs) (e.g., data packets processed within a particular communication layer 204 responsive to being received from another communication layer 204, such as responsive to modifying, removing, or adding header information or configuring payload information) and/or service data units (SDUs) (e.g., data packets as received from another communication layer 204, such as a higher layer 204).

The PDCP layer 204 can perform operations including header configuration or compression, data transfer, ciphering, and integrity protection. The RLC layer 204 can perform operations including data transfer, error correction, modifying how data is included in various data packets, and protocol error detection and recovery. The MAC layer 204 can perform operations including controlling the physical layer, such as to abstract operations of controlling the physical layer.

The communication layers 204 can communicate data packets using one or more communication paths 205, 207, 207 between respective layers 204. Each communication path 205, 207, 207 can be used to communicate data packets of varying types of data between respective layers 204. The communication paths 205, 207, 207 can include, for example, logic channels 205 (e.g., between the RLC layer 204 and MAC layer 204), radio data bearers 207 (e.g., between the RLC layer 204 and PDCP layer 204) and radio data bearers 207 (e.g., between the PDCP layer 204 and RRC and/or SDAP layers).

Referring further to FIG. 2, the base station 110 and UE 120 can communicate data packets between each other. The base station 110 can have a packet buffer 212, which can be implemented by various processing, communications, and/or memory components of the base station 110. The packet buffer 212 can maintain a plurality of data packets for transmission to the UE 120, such as for transmitting data packets using various arrangements according to the arrangement in the packet buffer 212 (e.g., first in first out (FIFO) buffering, among other arrangements). For example, the packet buffer 212 can have a queue of data packets for transmission. The base station 110 can assign data packets to the packet buffer 212, and can transmit a particular data packet to the UE 120 responsive to a transmission condition being satisfied, such as responsive to the particular data packet becoming a first data packet in the packet buffer 212 (e.g., such that all previously applied data packets have been transmitted or discarded). The packet buffer 212 can have at least one of a size or a capacity, such as size or capacity indicating at least one of an amount of data or a number of data packets that the packet buffer 212 can store.

The UE 120 can have a packet buffer 220, which can be similar or identical to the packet buffer 212, such as to buffer data packets received from or transmitted to the base station 110 (e.g., from or to packet buffer 212). As depicted in FIG. 2, the packet buffer 220 can be implemented for any one or more of the communication layers 204, such as for communication associated with communication paths including the logic channels 205, radio data bearers 206, and/or radio data bearers 207.

The packet buffer 220 (and/or the packet buffer 212) can be a de-jitter buffer. The de-jitter buffer can be used to adjust timing of data packet communication with applications to account for latency and/or jitter of the reception of the data packets. For example, an application using the data packets transmitted from the de-jitter buffer may have a first, expected packet processing rate, while the UE 120 (or the base station 110) can receive the data packets at a second rate that may vary from the first rate; the de-jitter buffer can store a plurality of data packets and can transmit data packets in the de-jitter buffer at the first rate to the application so that the application may maintain an appropriate processing rate even as the second rate of data packet reception by the UE 120 varies.

The base station 110 can discard data packets from the packet buffer 212 responsive to at least one discard criteria being satisfied. The discard criteria can correspond to a type of data of the data packets. For example, the base station 110 can determine that a particular data packet is eligible for discard responsive to determining that the particular data packet includes at least one of audio, text, speech, image, or video data, such as if the particular data packet has a destination of an application to implement augmented reality, extended reality, and/or virtual reality content.

The base station 110 can implement discard criteria including a discard timer. The discard timer can indicate a threshold duration of time which, responsive to the base station 110 determining has been exceeded, can enable or cause the base station 110 to discard a particular data packet from the packet buffer 212. The base station 110 can discard the particular data packet by removing (e.g., unassigning, unallocating) the particular data packet from the packet buffer 212 (which may result in data packets added to the packet buffer 212 after the particular data packet being moved forward in the packet buffer 212). The base station 110 can provide an indication to a source of the particular data packet that the particular data packet has been discarded.

The base station 110 can initiate a timer responsive to adding (e.g., assigning) the particular data packet to the packet buffer 212. The base station 110 can increment a value of the timer while the particular data packet is in the packet buffer 212, and can compare the value of the timer with a value of the discard timer. Responsive to the value of the timer meeting (or exceeding) the value of the discard timer, the base station 110 can discard the particular data packet from the packet buffer 212. The value of the discard timer can be a threshold value.

The base station 110 can determine the value of the discard timer as a duration of time. For example, the duration of time may be greater than zero seconds; a value of infinity or undefined may indicate that no discarding is to be performed. The base station 110 can identify the value of the discard timer from a plurality of values, such as from increments of 10 ms or various other increments.

The base station 110 can determine the value of the discard timer according to data received from the UE 120. Referring further to FIG. 2, the UE 120 can have timer configuration data 216. The UE 120 can provide a signal indicating at least a portion of the timer configuration data 216 to the base station 110, and can provide the signal using communication pathways that are the same as or different from those used to communicate data packets with the base station 110. The UE 120 can provide the signal as part of a user equipment assistance information (UAI; UE assistance information) signal. The UAI signal may be a signal that the UE 120 uses to communicate various types of configuration data to the base station 110. The UE 120 may communicate the signal differently than signals that provide data packets to the base station 110. For example, the UE 120 may communicate the signal less frequently, with different header information, using different channels, radio elements, or communication links, or in response to specific requests for the UAI from the base station 110. By providing the timer configuration data 216 using the UAI signal, the UE 120 can conserve or reduce radio resource usage, including to reduce power and/or network traffic. The UE 120 can provide the timer configuration data during, subsequent to, or responsive to the UE 120 establishing a wireless connection with the base station 110, enabling more flexible determination of the value of the discard timer.

The base station 110 can determine the value of the discard timer according to various portions of the timer configuration data 216 received from the UE 120. For example, the base station 110 can determine the value according information relating to timing considerations for data communication, such as information indicative of latency or jitter criteria being applicable to the data and/or the ability of devices of the system 200 to satisfy latency or jitter criteria. For example, to at least one of a type of an application implemented by the UE 120, a type of data of the particular data packet, or a hardware capability of the UE 120. The base station 110 (and the UE 120) can have any of various functions, rules, heuristics, models, databases, lookup tables, mappings, or combinations thereof to determine the value of the discard timer according to the timer configuration data 216.

The type of application can be indicative of communication of data packets associated with presenting extended reality, augmented reality, and/or virtual reality using the UE 120. For example, the data 208 can be generated by or for use by at least one of an extended reality application, an augmented reality application, an artificial reality application, or a virtual reality application implemented by the UE 120. Various such applications may have latency and/or jitter criteria associated with using the data 208 for presenting content to a user, such that inaccurate, untimely, or unnecessary discarding of packets may reduce the quality of the presentation of content.

The type of data can be indicative of whether the data is to be used for presenting content associated with timing criteria, such as latency or jitter criteria. For example, the UE 120 can determine the timer configuration data 216 responsive to determining that the data 208 (or data of data packets to be received or transmitted by applications being operated) includes at least one of text data, speech data, voice data, audio data, image data, sensor data, tracking data, video data, or other data used for time-sensitive applications such as artificial reality, extended reality, augmented reality, and/or virtual reality applications.

The hardware capability can be indicative of the ability of the UE 120 to receive, process, and/or provide data packets to applications in a timely manner. For example, the UE 120 can determine the timer configuration data 216 according to hardware capability of the UE 120 such as communication throughput (e.g., bandwidth, signal strength, signal quality, number of communication channels such as paths 205, 206, 207 or radio chains), processing capacity, memory capacity, battery capacity, or various combinations thereof. The UE 120 can determine the hardware capability (e.g., determine communication throughput information) according to the at least one of the size or the capacity of the packet buffer 220 (or the packet buffer 212).

The base station 110 can determine the value of the discard timer for a subset of data packets, enabling the base station 110 to differentiate amongst data flows of the data packets to more flexibly configure the discard timer. For example, for a particular data packet (or subset of data packets), the base station 110 can determine the value of the discard timer according (1) a destination application of the particular data packet and (2) at least a portion of the timer configuration data 216. As such, even where data packets associated with different applications or types of data are arranged in the same data flow for at least a portion of a communication pathway, such as over logical channels 205, radio data bearers 206, radio data bearers 207, QoS flows, or various combinations thereof (which arrangements the base station 110 may not have visibility into or have control over), the base station 110 can more discretely and flexibly control data packet discarding.

Referring further to FIG. 2, the UE 120 can configure a value of a discard timer for the packet buffer 220. For example, the UE 120 can determine the value according to the timer configuration data 216, including data received from the application layer. As such, the UE 120 can control discarding of data packets more flexibly and specifically to the type of data represented by the data packets, the applications using the data packets, and/or the communication capabilities of the UE 120.

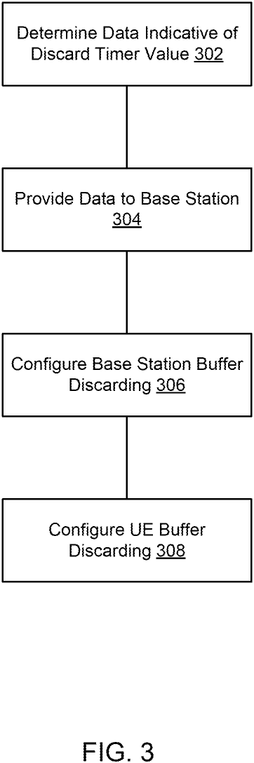

FIG. 3 shows a block diagram of a representative method 300 for dynamic discard timer adjustment for wireless communications. In some implementations, at least a portion of the method 300 can be implemented by a first device, such as a UE, configured to communicate (e.g., transmit/receive via uplink/downlink connections) data packets with a second device, such as a base station, via a wireless network connection. In brief overview, the first device can determine 302 data indicative of a discard timer value can be determined. The first device can provide 304 the data to the base station. The base station can configure 306 a base station buffer according to the data. The UE can control 308 a UE buffer according to the data. The method 300 can be performed by various devices and systems described herein, including but not limited to the base station 110 and UE 120. In some implementations, the method 300 can include more, fewer, or different operations than shown in FIG. 3.

Referring to FIG. 3 in further detail, the UE can determine 302 data indicative of discard timing, such as data that can be used to determine a value of a discard timer used to discard data packets from a buffer. The data can correspond to parameters of the UE, data communicated by the UE, applications operated by the UE, or components of the UE. For example, the UE can determine the data according to at least one of a type of an application implemented by the one or more processors, a type of data communicated over the wireless connection, or a hardware capability of the device. The UE can determine the data periodically according to a schedule or can determine the data responsive to various triggers. For example, the UE can determine the data responsive to triggers such as detecting a change in operating state of the UE (e.g., waking from a sleep state, switching from a normal power usage mode to a low power usage mode or vice versa), responsive to the UE establishing communication with the base station, responsive to a request from the base station, responsive to detecting initialization of an application, responsive to detecting packet transmission from the application, or various combinations thereof. The UE can determine the data according to a schedule corresponding to transmission of UE assistance information, such as to include the data in each UE assistance information signal or a subset of UE assistance information signals. The UE can determine the data subsequent to a wireless communication interface of the UE establishing a wireless connection with the base station. The UE can periodically update the data responsive to the schedule, triggers, or various combinations thereof.

The UE can provide 304 the data to the base station. For example, the UE can provide the data using the wireless connection established with the base station, which may be the same wireless connection or a different wireless connection than that used to communicate data packets with the base station. The UE can provide the data in the UE assistance information signal. The UE can provide the data responsive to determining the data, or according to a schedule or triggers different than those used to determine the data. For example, the UE can determine the data responsive to initialization of an application, and can provide the data to the base station responsive to a request from the base station or responsive to a schedule of UE assistance information transmission.

The UE and/or the base station can perform various discard timer configuration operations according to the data. For example, the base station can configure 306 a discard timer of a buffer of the base station according to at least a subset of the data. The base station can control the discard timer by determining a value of the discard timer, such as a value indicating a maximum threshold for holding data packets in the buffer, according to the data. The base station can determine the value for each type of data, or each application or type of application indicated as a destination of the data packet, to determine the value of a corresponding discard timer. The base station can determine the value according to capabilities of the UE (e.g., capabilities such as network communications, internal communications, hardware processing and/or memory capacity), such as to determine a relatively greater value responsive to the UE having a relatively greater capability (since the UE may be able to complete processing of data packets in relatively less time where the UE has relatively greater capability) or a relatively lesser value responsive to the UE having a relatively lesser capability.

The UE can configure 308 a discard timer of a buffer of the UE according to at least a subset of the data. For example, the UE can use information relating to applications operated by the UE and relating to data packets in the buffer, such as where the buffer is a de-jitter buffer, to configure the discard timer. For example, the UE can identify a destination application of a particular packet, can determine that the destination application has timing-related performance criteria (e.g., responsive to identifying the destination application as an application presenting at least one of augmented reality, artificial reality, extended reality, or virtual reality content), and can select the value of the discard timer from a plurality of discard timer values according to a timing associated with operation of the destination application (e.g., a frame rate). As another example, the UE can determine that the data packet has audio data to be presented together with video data (which may be provided in a different data packet), and can determine the value of the discard timer according to the frame rate of presenting the video data. At least one of the UE or the base station can use the respective buffer and discard timer by assigning a data packet to the respective buffer, initiating a timer responsive to determining that the data packet includes data eligible for discard (e.g., data having a destination application that has timing criteria, audio data, text data, speech data, image data, video data), can periodically increment the timer, can compare the time with the value of the discard timer, and can discard the data packet responsive to the timer meeting or exceeding the value of the discard timer (e.g., before the data packet is provided to a destination).

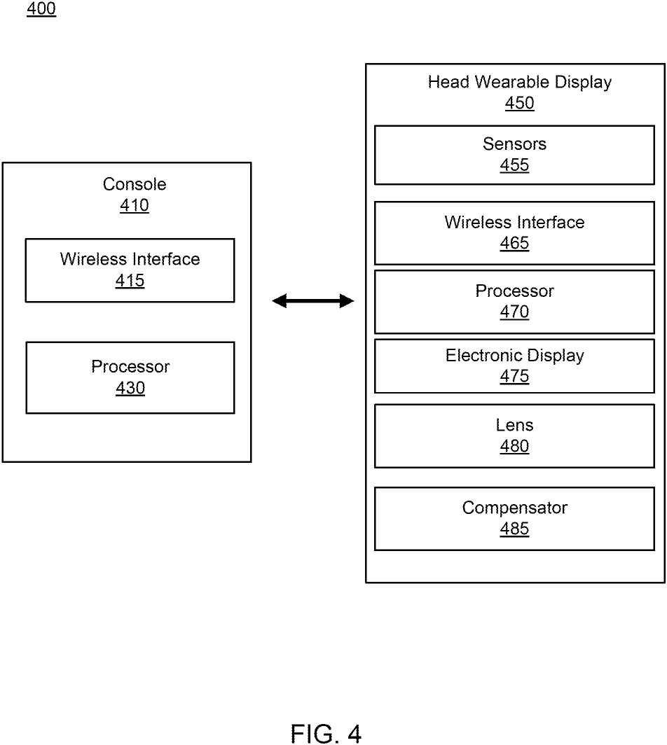

FIG. 4 is a block diagram of an example artificial reality system environment 400. The artificial reality system environment 400 may be implemented using and/or used to implement various devices and systems described herein, including but not limited to the wireless communication system 100 and the system 200. In some implementations, the artificial reality system environment 400 includes a HWD 450 worn by a user, and a console 410 providing content of artificial reality (e.g., augmented reality, virtual reality, mixed reality) to the HWD 450. Each of the HWD 450 and the console 410 may be a separate UE 120. The HWD 450 may be referred to as, include, or be part of a head mounted display (HMD), head mounted device (HMD), head wearable device (HWD), head worn display (HWD) or head worn device (HWD). The HWD 450 may detect its location and/or orientation of the HWD 450 as well as a shape, location, and/or an orientation of the body/hand/face of the user, and provide the detected location/or orientation of the HWD 450 and/or tracking information indicating the shape, location, and/or orientation of the body/hand/face to the console 410. The console 410 may generate image data indicating an image of the artificial reality according to the detected location and/or orientation of the HWD 450, the detected shape, location and/or orientation of the body/hand/face of the user, and/or a user input for the artificial reality, and transmit the image data to the HWD 450 for presentation. In some implementations, the artificial reality system environment 400 includes more, fewer, or different components than shown in FIG. 4. In some implementations, functionality of one or more components of the artificial reality system environment 400 can be distributed among the components in a different manner than is described here. For example, some of the functionality of the console 410 may be performed by the HWD 450. For example, some of the functionality of the HWD 450 may be performed by the console 410. In some implementations, the console 410 is integrated as part of the HWD 450.

In some implementations, the HWD 450 is an electronic component that can be worn by a user and can present or provide an artificial reality experience to the user. The HWD 450 may render one or more images, video, audio, or some combination thereof to provide the artificial reality experience to the user. In some implementations, audio is presented via an external device (e.g., speakers and/or headphones) that receives audio information from the HWD 450, the console 410, or both, and presents audio based on the audio information. In some implementations, the HWD 450 includes sensors 455, a wireless interface 475, a processor 470, an electronic display 475, a lens 480, and a compensator 485. These components may operate together to detect a location of the HWD 450 and a gaze direction of the user wearing the HWD 450, and render an image of a view within the artificial reality corresponding to the detected location and/or orientation of the HWD 450. In other implementations, the HWD 450 includes more, fewer, or different components than shown in FIG. 4.

In some implementations, the sensors 455 include electronic components or a combination of electronic components and software components that detect a location and an orientation of the HWD 450. Examples of the sensors 455 can include: one or more imaging sensors, one or more accelerometers, one or more gyroscopes, one or more magnetometers, or another suitable type of sensor that detects motion and/or location. For example, one or more accelerometers can measure translational movement (e.g., forward/back, up/down, left/right) and one or more gyroscopes can measure rotational movement (e.g., pitch, yaw, roll). In some implementations, the sensors 455 detect the translational movement and the rotational movement, and determine an orientation and location of the HWD 450. In one aspect, the sensors 455 can detect the translational movement and the rotational movement with respect to a previous orientation and location of the HWD 450, and determine a new orientation and/or location of the HWD 450 by accumulating or integrating the detected translational movement and/or the rotational movement. Assuming for an example that the HWD 450 is oriented in a direction 25 degrees from a reference direction, in response to detecting that the HWD 450 has rotated 20 degrees, the sensors 455 may determine that the HWD 450 now faces or is oriented in a direction 45 degrees from the reference direction. Assuming for another example that the HWD 450 was located two feet away from a reference point in a first direction, in response to detecting that the HWD 450 has moved three feet in a second direction, the sensors 455 may determine that the HWD 450 is now located at a vector multiplication of the two feet in the first direction and the three feet in the second direction.

In some implementations, the sensors 455 include eye trackers. The eye trackers may include electronic components or a combination of electronic components and software components that determine a gaze direction of the user of the HWD 450. In some implementations, the HWD 450, the console 410 or a combination of them may incorporate the gaze direction of the user of the HWD 450 to generate image data for artificial reality. In some implementations, the eye trackers include two eye trackers, where each eye tracker captures an image of a corresponding eye and determines a gaze direction of the eye. In one example, the eye tracker determines an angular rotation of the eye, a translation of the eye, a change in the torsion of the eye, and/or a change in shape of the eye, according to the captured image of the eye, and determines the relative gaze direction with respect to the HWD 450, according to the determined angular rotation, translation and the change in the torsion of the eye. In one approach, the eye tracker may shine or project a predetermined reference or structured pattern on a portion of the eye, and capture an image of the eye to analyze the pattern projected on the portion of the eye to determine a relative gaze direction of the eye with respect to the HWD 450. In some implementations, the eye trackers incorporate the orientation of the HWD 450 and the relative gaze direction with respect to the HWD 450 to determine a gate direction of the user. Assuming for an example that the HWD 450 is oriented at a direction 30 degrees from a reference direction, and the relative gaze direction of the HWD 450 is -10 degrees (or 350 degrees) with respect to the HWD 450, the eye trackers may determine that the gaze direction of the user is 20 degrees from the reference direction. In some implementations, a user of the HWD 450 can configure the HWD 450 (e.g., via user settings) to enable or disable the eye trackers. In some implementations, a user of the HWD 450 is prompted to enable or disable the eye trackers.

In some implementations, the wireless interface 475 includes an electronic component or a combination of an electronic component and a software component that communicates with the console 410. The wireless interface 475 may be or correspond to the wireless interface 122. The wireless interface 475 may communicate with a wireless interface 415 of the console 410 through a wireless communication link through the base station 110. Through the communication link, the wireless interface 475 may transmit to the console 410 data indicating the determined location and/or orientation of the HWD 450, and/or the determined gaze direction of the user. Moreover, through the communication link, the wireless interface 475 may receive from the console 410 image data indicating or corresponding to an image to be rendered and additional data associated with the image.

In some implementations, the processor 470 includes an electronic component or a combination of an electronic component and a software component that generates one or more images for display, for example, according to a change in view of the space of the artificial reality. In some implementations, the processor 470 is implemented as a part of the processor 124 or is communicatively coupled to the processor 124. In some implementations, the processor 470 is implemented as a processor (or a graphical processing unit (GPU)) that executes instructions to perform various functions described herein. The processor 470 may receive, through the wireless interface 475, image data describing an image of artificial reality to be rendered and additional data associated with the image, and render the image to display through the electronic display 475. In some implementations, the image data from the console 410 may be encoded, and the processor 470 may decode the image data to render the image. In some implementations, the processor 470 receives, from the console 410 in additional data, object information indicating virtual objects in the artificial reality space and depth information indicating depth (or distances from the HWD 450) of the virtual objects. In one aspect, according to the image of the artificial reality, object information, depth information from the console 410, and/or updated sensor measurements from the sensors 455, the processor 470 may perform shading, reprojection, and/or blending to update the image of the artificial reality to correspond to the updated location and/or orientation of the HWD 450. Assuming that a user rotated his head after the initial sensor measurements, rather than recreating the entire image responsive to the updated sensor measurements, the processor 470 may generate a small portion (e.g., 10 %) of an image corresponding to an updated view within the artificial reality according to the updated sensor measurements, and append the portion to the image in the image data from the console 410 through reprojection. The processor 470 may perform shading and/or blending on the appended edges. Hence, without recreating the image of the artificial reality according to the updated sensor measurements, the processor 470 can generate the image of the artificial reality.

In some implementations, the electronic display 475 is an electronic component that displays an image. The electronic display 475 may, for example, be a liquid crystal display or an organic light emitting diode display. The electronic display 475 may be a transparent display that allows the user to see through. In some implementations, when the HWD 450 is worn by a user, the electronic display 475 is located proximate (e.g., less than 3 inches) to the user’s eyes. In one aspect, the electronic display 475 emits or projects light towards the user’s eyes according to image generated by the processor 470.

In some implementations, the lens 480 is a mechanical component that alters received light from the electronic display 475. The lens 480 may magnify the light from the electronic display 475, and correct for optical error associated with the light. The lens 480 may be a Fresnel lens, a convex lens, a concave lens, a filter, or any suitable optical component that alters the light from the electronic display 475. Through the lens 480, light from the electronic display 475 can reach the pupils, such that the user can see the image displayed by the electronic display 475, despite the close proximity of the electronic display 475 to the eyes.

In some implementations, the compensator 485 includes an electronic component or a combination of an electronic component and a software component that performs compensation to compensate for any distortions or aberrations. In one aspect, the lens 480 introduces optical aberrations such as a chromatic aberration, a pin-cushion distortion, barrel distortion, etc. The compensator 485 may determine a compensation (e.g., predistortion) to apply to the image to be rendered from the processor 470 to compensate for the distortions caused by the lens 480, and apply the determined compensation to the image from the processor 470. The compensator 485 may provide the predistorted image to the electronic display 475.

In some implementations, the console 410 is an electronic component or a combination of an electronic component and a software component that provides content to be rendered to the HWD 450. In one aspect, the console 410 includes a wireless interface 415 and a processor 430. These components may operate together to determine a view (e.g., a FOV of the user) of the artificial reality corresponding to the location of the HWD 450 and the gaze direction of the user of the HWD 450, and can generate image data indicating an image of the artificial reality corresponding to the determined view. In addition, these components may operate together to generate additional data associated with the image. Additional data may be information associated with presenting or rendering the artificial reality other than the image of the artificial reality. Examples of additional data include, hand model data, mapping information for translating a location and an orientation of the HWD 450 in a physical space into a virtual space (or simultaneous localization and mapping (SLAM) data), eye tracking data, motion vector information, depth information, edge information, object information, etc. The console 410 may provide the image data and the additional data to the HWD 450 for presentation of the artificial reality. In other implementations, the console 410 includes more, fewer, or different components than shown in FIG. 4. In some implementations, the console 410 is integrated as part of the HWD 450.

In some implementations, the wireless interface 415 is an electronic component or a combination of an electronic component and a software component that communicates with the HWD 450. The wireless interface 415 may be or correspond to the wireless interface 144. The wireless interface 415 may be a counterpart component to the wireless interface 475 to communicate through a communication link (e.g., wireless communication link). Through the communication link, the wireless interface 415 may receive from the HWD 450 data indicating the determined location and/or orientation of the HWD 450, and/or the determined gaze direction of the user. Moreover, through the communication link, the wireless interface 415 may transmit to the HWD 450 image data describing an image to be rendered and additional data associated with the image of the artificial reality.

The processor 430 can include or correspond to a component that generates content to be rendered according to the location and/or orientation of the HWD 450. In some implementations, the processor 430 is implemented as a part of the processor 144 or is communicatively coupled to the processor 144. In some implementations, the processor 430 may incorporate the gaze direction of the user of the HWD 450. In one aspect, the processor 430 determines a view of the artificial reality according to the location and/or orientation of the HWD 450. For example, the processor 430 maps the location of the HWD 450 in a physical space to a location within an artificial reality space, and determines a view of the artificial reality space along a direction corresponding to the mapped orientation from the mapped location in the artificial reality space. The processor 430 may generate image data describing an image of the determined view of the artificial reality space, and transmit the image data to the HWD 450 through the wireless interface 415. In some implementations, the processor 430 may generate additional data including motion vector information, depth information, edge information, object information, hand model data, etc., associated with the image, and transmit the additional data together with the image data to the HWD 450 through the wireless interface 415. The processor 430 may encode the image data describing the image, and can transmit the encoded data to the HWD 450. In some implementations, the processor 430 generates and provides the image data to the HWD 450 periodically (e.g., every 11 ms).

In one aspect, the process of detecting the location of the HWD 450 and the gaze direction of the user wearing the HWD 450, and rendering the image to the user should be performed within a frame time (e.g., 11 ms or 17 ms). A latency between a movement of the user wearing the HWD 450 and an image displayed corresponding to the user movement can cause judder, which may result in motion sickness and can degrade the user experience. In one aspect, the HWD 450 and the console 410 can prioritize communication for AR/VR, such that the latency between the movement of the user wearing the HWD 450 and the image displayed corresponding to the user movement can be presented within the frame time (e.g., 11 ms or 17 ms) to provide a seamless experience.

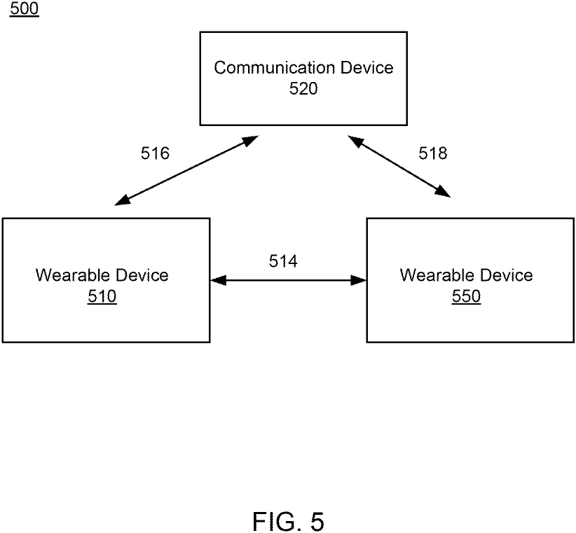

FIG. 5 is a block diagram of an example system 500, which can be used to implement or be implemented by various systems and devices described herein. In some implementations, the system 500 includes a communication device 520, a wearable device 510, and a wearable device 550. The wearable device 510 may be a smart watch, and the wearable device 550 may be a head wearable device (HWD) 550. The communication device 520 may be an access point or any other communication device. The HWD 550 may be referred to as, include, or be part of a head mounted display (HMD), head mounted device (HMD), head worn display (HWD) or head worn device (HWD). The wearable device 510 and the HWD 550 may communicate with each other through a communication link 514. The wearable device 510 and the communication device 520 may communicate with each other through a communication link 517, and the wearable device 550 and the communication device 520 may communicate with each other through a communication link 518. Through the wireless links 517, 518, the wearable devices 510, 550 may access content (e.g., text, image, audio, video, etc.) from other devices. The communication links 514, 517, 518 may be wireless links (e.g., cellular link, Wi-Fi link, Bluetooth link, 70 GHz link, ultra wideband link, etc.). The communication links 514, 517, 518 may be based on the same protocol or different protocols. For example, the communication links 517, 518 may conform to the 3G, 4G, 5G, LTE, 70 GHz protocol, where the communication link 514 may conform to the Wi-Fi link, Bluetooth, etc. In some implementations, the system 500 includes more, fewer, or different components than shown in FIG. 5.

In one aspect, the wearable device 510 and the wearable device 550 may operate together to provide/support artificial reality for a user. In one example, the wearable device 550 may detect a location and an orientation of the wearable device 550, and generate a sensor measurement indicating the detected location and orientation of the wearable device 550. The wearable device 550 may transmit the sensor measurement to the wearable device 510 through the communication link 514. The wearable device 510 may receive the sensor measurement, and may generate or determine a view of the artificial reality corresponding to the detected location and orientation of the wearable device 550. The wearable device 510 may generate image data of the determined view of the artificial reality, and transmit the image data to the wearable device 550 through the communication link 514. The HWD 550 may receive the image data, and can present an image of the artificial reality to a user according to the image data. In one aspect, the process of detecting the location and the orientation of the HWD 550, and rendering the image to the user should be performed within a frame time (e.g., 11 ms or 17 ms). Any latency between a movement of the user wearing the HWD and an image displayed corresponding to the user movement can cause judder, which may result in motion sickness and can degrade the user experience.

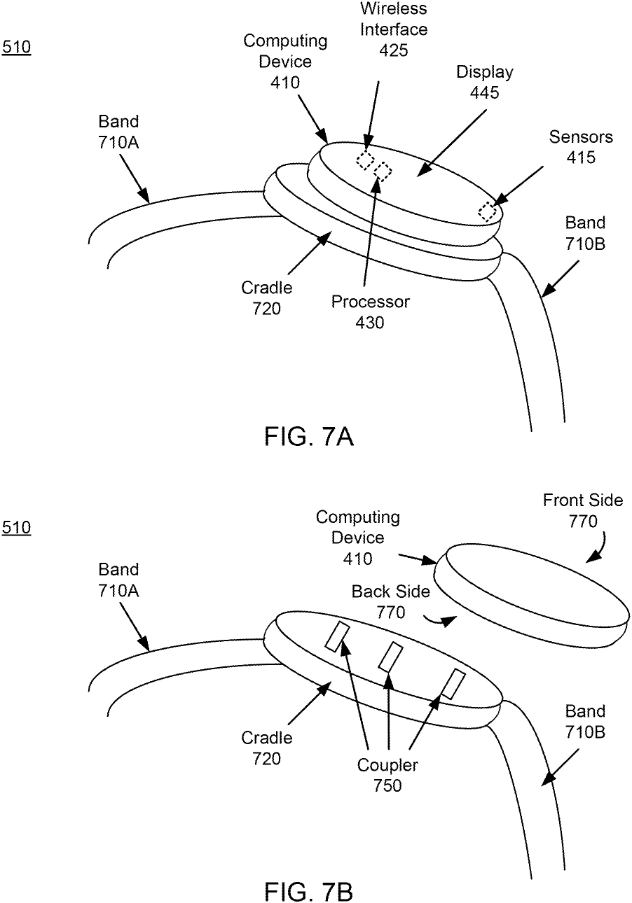

FIG. 7 is a diagram of an example of the HWD 450, in accordance with an example implementation. In some implementations, the HWD 450 includes a front rigid body 705 and a band 710. The front rigid body 705 includes the electronic display 475 (not shown in FIG. 7), the lens 480 (not shown in FIG. 7), the sensors 455, the wireless interface 475, and the processor 470. In the implementation shown by FIG. 7, the wireless interface 475, the processor 470, and the sensors 455 are located within the front rigid body 405, and may not be visible externally. In other implementations, the HWD 450 has a different configuration than shown in FIG. 7. For example, the wireless interface 475, the processor 470, and/or the sensors 455 may be in different locations than shown in FIG. 7.

FIG. 7A is a diagram showing a perspective view of the wearable device 110A including a computing device 410 attached to a cradle 720, according to an example implementation of the present disclosure. The processor 430, the wireless communication interface 425 and the sensors 415 may be disposed within a housing of the computing device 410, such that the processor 430, the wireless communication interface 425 and the sensors 415 may not be visible to the user. The computing device 410 may also include the display 445 on a front side 770 to present text or image. The computing device 410 may be detachable from the cradle 720 as shown in FIG. 7B. The computing device 710 may be detached from the cradle 720 to allow the user to charge the battery of the computing device 710, connect to another device through a cable, or capture an image, etc. The cradle 720 may be a wearable structure or a component to selectively hold, contain, connect, grasp and/or couple the computing device 410. The cradle 720 may include one or more couplers 750, to which a back side 770 or other portion of the computing device 210 can be attached. One or more couplers 750 may include mechanical latches, magnetics, hook and loop fasteners, or any component(s) that allow the cradle 720 to selectively hold or couple the computing device 410. The cradle 720 may include or may be attached to wrist bands 710A, 720B.

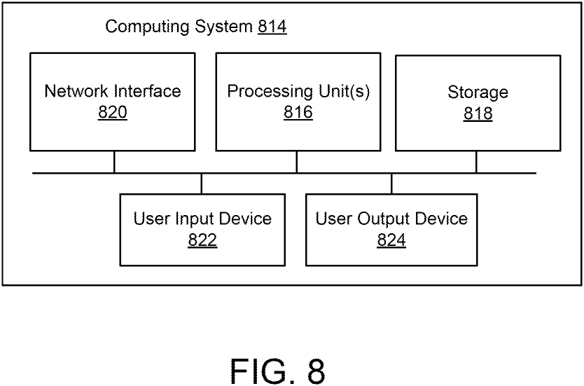

Various operations described herein can be implemented on computer systems. FIG. 8 shows a block diagram of a representative computing system 814 usable to implement various systems and devices of the present disclosure. Computing system 814 can be implemented, for example, as a consumer device such as a smartphone, other mobile phone, tablet computer, wearable computing device (e.g., smart watch, eyeglasses, head wearable display), desktop computer, laptop computer, or implemented with distributed computing devices. The computing system 814 can be implemented to provide VR, AR, MR experience. In some implementations, the computing system 814 can include conventional computer components such as processors (e.g., processing units) 816, storage device 416, network interface 820, user input device 822, and user output device 824.

Network interface 820 can provide a connection to a wide area network (e.g., the Internet) to which WAN interface of a remote server system is also connected. Network interface 420 can include a wired interface (e.g., Ethernet) and/or a wireless interface implementing various RF data communication standards such as Wi-Fi, Bluetooth, or cellular data network standards (e.g., 3G, 4G, 5G, 70 GHz, LTE, etc.).

The network interface 820 may include a transceiver to allow the computing system 814 to transmit and receive data from a remote device using a transmitter and receiver. The transceiver may be configured to support transmission/reception supporting industry standards that enables bi-directional communication. An antenna may be attached to transceiver housing and electrically coupled to the transceiver. Additionally or alternatively, a multi-antenna array may be electrically coupled to the transceiver such that a plurality of beams pointing in distinct directions may facilitate in transmitting and/or receiving data.

A transmitter may be configured to wirelessly transmit frames, slots, or symbols generated by the processor unit 816. Similarly, a receiver may be configured to receive frames, slots or symbols and the processor unit 816 may be configured to process the frames. For example, the processor unit 816 can be configured to determine a type of frame and to process the frame and/or fields of the frame accordingly.

User input device 822 can include any device (or devices) via which a user can provide signals to computing system 814; computing system 814 can interpret the signals as indicative of particular user requests or information. User input device 822 can include any or all of a keyboard, touch pad, touch screen, mouse or other pointing device, scroll wheel, click wheel, dial, button, switch, keypad, microphone, sensors (e.g., a motion sensor, an eye tracking sensor, etc.), and so on.

User output device 824 can include any device via which computing system 814 can provide information to a user. For example, user output device 824 can include a display to display images generated by or delivered to computing system 814. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). A device such as a touchscreen that function as both input and output device can be used. Output devices 824 can be provided in addition to or instead of a display. Examples include indicator lights, speakers, tactile “display” devices, printers, and so on.

Some implementations include electronic components, such as microprocessors, storage and memory that store computer program instructions in a computer readable storage medium (e.g., non-transitory computer readable medium). Many of the features described in this specification can be implemented as processes that are specified as a set of program instructions encoded on a computer readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processor 417 can provide various functionality for computing system 814, including any of the functionality described herein as being performed by a server or client, or other functionality associated with message management services.

It will be appreciated that computing system 814 is illustrative and that variations and modifications are possible. Computer systems used in connection with the present disclosure can have other capabilities not specifically described here. Further, while computing system 814 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the implementations disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or nonvolatile memory, and may include database components, object code components, script components, or any other type of information structure for supporting the various activities and information structures described in the present disclosure. According to an exemplary implementation, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The implementations of the present disclosure may be implemented using existing computer processors, or by a special purpose computer processor for an appropriate system, incorporated for this or another purpose, or by a hardwired system. Implementations within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or implementation, and references to “an implementation,” “some implementations,” “one implementation” or the like are not necessarily mutually exclusive and are intended to indicate that a particular feature, structure, or characteristic described in connection with the implementation can be included in at least one implementation or implementation. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/-10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary implementations, and that such variations are intended to be encompassed by the present disclosure.

What is claimed is:

1. A device, comprising:
a wireless communication interface configured to establish a wireless connection with a remote device; and
one or more processors configured to:
determine a signal indicative of a value of a discard timer according to at least one of a type of an application implemented by the one or more processors, a type of data communicated over the wireless connection, or a hardware capability of the device, wherein the discard timer is for discarding data packets from one or more buffers; and
providing, by the one or more processors, the signal to the remote device.

2. The device of claim 1, wherein the one or more processors are configured to determine the value and provide the signal to the remote device subsequent to the wireless communication interface establishing the wireless connection with the remote device.

3. The device of claim 1, wherein:
at least one of the wireless communication interface or the one or more processors operate a particular buffer of the one or more buffers for transmitting data from the device to the remote device; and
the at least one of the wireless communication interface or the one or more processors are configured to:
assign a data packet generated by the application to the particular buffer;
initiate a timer responsive to determining that the data packet comprises data of a type for discard;
periodically increment the timer while the data packet is in the particular buffer; and
discard the data packet responsive to the timer meeting or exceeding the value of the discard timer.

4. The device of claim 1, wherein the device is configured to provide the signal as a user equipment assistance information signal, the user equipment assistance information signal transmitted to the remote device differently than data generated by the application, wherein the remote device is a base station.

5. The device of claim 1, wherein the one or more buffers comprises at least one de-jitter buffer, the de-jitter buffer to store data packets comprising at least one of image data or voice data.

6. The device of claim 1, wherein the one or more processors provide the signal to the remote device for the remote device to set a value of a discard timer of a particular buffer of the one or more buffers according to the signal, wherein the remote device is a base station.

7. The device of claim 1, wherein the type of application comprises at least one of an extended reality application, an augmented reality application, or a virtual reality application.

8. The device of claim 1, wherein the one or more processors are configured to determine the hardware capability according to a size of a particular buffer of the one or more buffers.

9. A method, comprising:
determining, by a first device, a signal indicative of a value of a discard timer according to at least one of a type of an application of the first device, a type of data communicated over the wireless connection, or a hardware capability of the first device, wherein the discard timer is for discarding data packets from one or more buffers; and
providing, by the first device, the signal to a second device.

10. The method of claim 9, further comprising:
determining, by the first device, the value subsequent to the first device establishing the wireless connection with the remote device.

11. The method of claim 9, further comprising:
assigning, by the first device, a data packet generated by the application to the particular buffer;
initiating, by the first device, a timer responsive to determining that the data packet comprises data of a type for discard;
periodically incrementing, by the first device, the timer while the data packet is in the particular buffer; and
discarding, by the first device, the data packet responsive to the timer meeting or exceeding the value of the discard timer.

12. The method of claim 9, further comprising providing, by the first device, the signal as a user equipment assistance information signal, the user equipment assistance information signal transmitted to the second device differently than data generated by the application, wherein the second device is a base station.

13. The method of claim 9, wherein the one or more buffers comprises at least one de-jitter buffer, the de-jitter buffer to store data packets comprising at least one of image data or voice data.

14. The method of claim 9, further comprising setting, by the second device, a value of a discard timer of a particular buffer of the one or more buffers according to the signal, wherein the second device is a base station.

15. The method of claim 9, wherein the type of application comprises at least one of an extended reality application, an augmented reality application, or a virtual reality application.

16. The method of claim 9, further comprising determining, by the first device, the hardware capability according to a size of a particular buffer of the one or more buffers.

17. A non-transitory computer readable medium storing instructions when executed by one or more processors of a device, cause the one or more processors to:
determine a signal indicative of a value of a discard timer according to at least one of a type of an application implemented by the one or more processors, a type of data communicated over the wireless connection, or a hardware capability of the device, the discard timer for discarding data packets from a de-jitter buffer; and
provide the signal to a base station.

18. The non-transitory computer readable medium of claim 17, wherein the instructions are to cause the one or more processors to provide the signal to the base station as a user equipment assistance information signal during establishment of or subsequent to a wireless communication interface establishing a wireless connection with the base station.

19. The non-transitory computer readable medium of claim 17, wherein the data communicated over the wireless connection comprises at least one of audio data, image data, tracking data, sensor data, or video data.

20. The non-transitory computer readable medium of claim 17, wherein the type of application comprises at least one of an extended reality application, an augmented reality application, or a virtual reality application.
